(19) United States
(12) Patent Application Publication
(10) Pub. No.: US 2004/0233470 A1
(43) Pub. Date: Nov. 25, 2004

(54) Recording a date using a memory of a printing device component

(76) Inventors: Roman T. Wachter, Boise, ID (US); Jeetendra Kumar, Boise, ID (US); Nataraj Kumar Gobbak, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/444,843

(22) Filed: May 23, 2003

(51) Int. Cl. G06F 3/12; G06F 15/00; G06F 3/00

(52) U.S. Cl. 358/1.14; 399/27; 347/19; 710/19

(57) ABSTRACT

A printing device capable of using a replaceable component. The printing device can detect the component being installed into the printing device. The printing device can determine an install date of the component. The printing device can write the install date of the component into a memory attached to the component.

### BACKGROUND OF THE INVENTION

Printing devices may include one or more components that are replaced (sometimes more than once) over the lifetime of the device. It may be desirable (for any number of reasons) to know when a component is installed in a printing device. Obtaining this type of information, however, can be difficult.

### BRIEF DESCRIPTION OF THE DRAWINGS

FIG. 1 is a block diagram of an exemplary printing system;

FIG. 2 is a block diagram illustrating certain components in an exemplary printing device;

FIG. 3 is a block diagram illustrating certain aspects of an exemplary print cartridge memory;

FIG. 4A and FIG. 4B are flow diagrams for illustrating an exemplary procedure a printing device may follow;

FIG. 5 is a block diagram of an exemplary computer system for retrieving data from print cartridge memory;

FIG. 6 is a flow diagram illustrating an exemplary procedure a computer may follow to retrieve certain data from the cartridge memory;

FIG. 7 is a block diagram of an exemplary printing device; and

FIG. 8 is a block diagram of an exemplary server system.

### DETAILED DESCRIPTION OF THE INVENTION

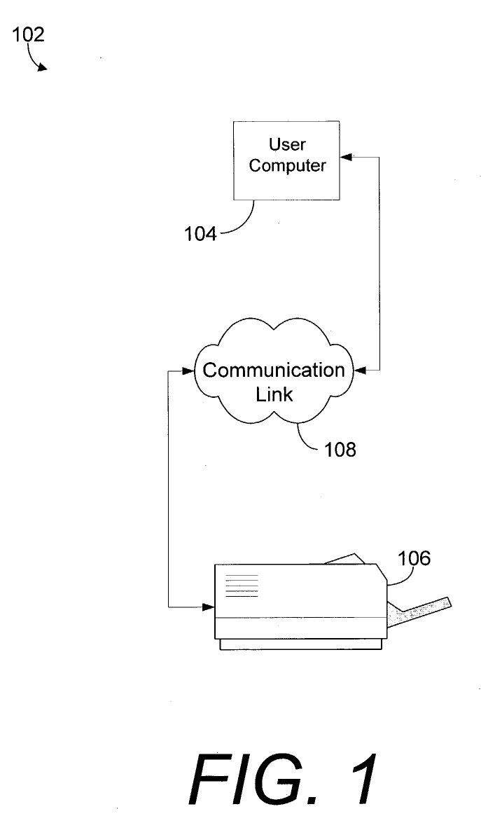

FIG. 1 illustrates a printing system 102 that incorporates one example embodiment of the invention. As shown, the printing system 102 includes a user computer 104 connected to a printing device 106 via a communication link 108.

The user computer 104 may represent any type of computer that can transmit a print job to the printing device 106. Thus, for example, the user computer 104 may represent a personal computer, a personal digital assistant and/or a cell phone, etc.

The communication link 108 may represent any type of communication path that can enable the user computer 104 to transmit a print job to the printing device 106. Thus, for example, the communication link 108 may represent a cable, a wireless communication path, a network system, and/or the INTRANET, etc.

The printing device 106 may represent any type of device that can convert a print job, received over the communication link 108, into a printed form. Thus, for example, the printing device 106 may represent a laser printer, an ink printer, a commercial printing press, etc. The printing device 106 may provide more than just a printing function. For example, the printing device 106 may allow a walk-up user to scan hard copy documents, transmit e-mails, etc.

Components of the Exemplary Printing Device

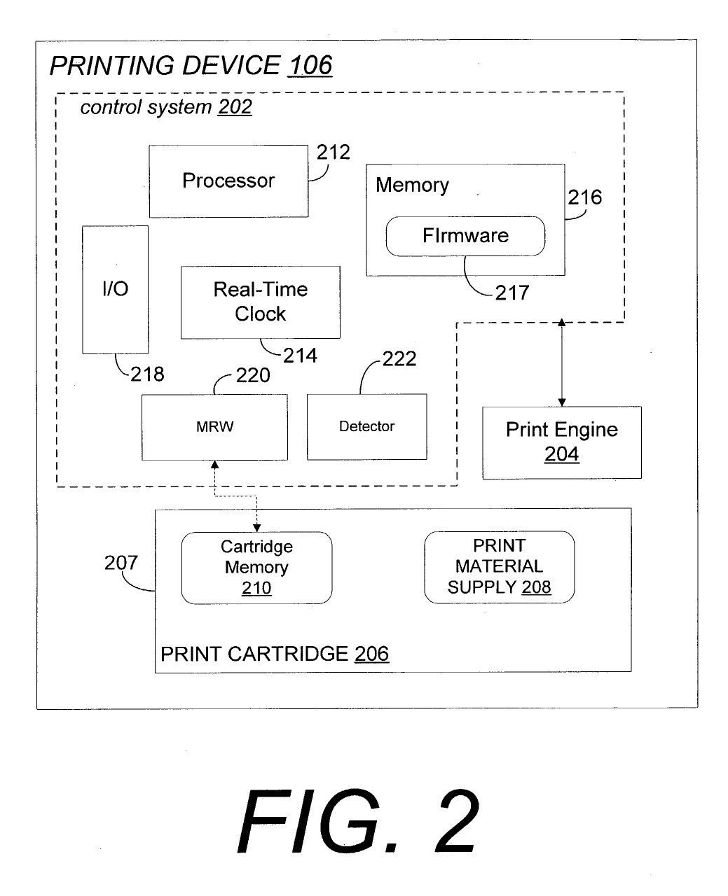

FIG. 2 is a high-level block diagram showing some of the components of the exemplary printing device 106.

As shown, the printing device 106 includes a control system 202, a print engine 204, and a component that includes integrated memory. In this example, the component is a replaceable print cartridge 206. The printing device 106 may also include a number of other components and/subsystems that are not shown. For example, the printing device 106 may include one or more additional print cartridges, a hard drive system, etc.

The print engine 204 includes the appropriate mechanisms for enabling the printing device 106 to generate printed output. The print engine 204 may enable the printing device 106 to generate printed output in color, in monochrome, or both.

It is also noted that the print engine 204 may employ any type of printing technology that uses one or more print materials (e.g., liquid toner, dry toner, ink, etc.) to selectively place marks on a print medium. For example, the print engine 204 may represent a laser print engine that uses dry toner and/or liquid toner to place marks on a print medium. In other implementations, for example, the print engine 204 may represent an ink jet print engine that uses liquid ink to place marks on a print medium.

The print cartridge 206 includes a housing 207 that contains a supply of print material 208 (e.g., liquid toner, dry toner, ink, etc.) for the print engine 204. During printing, therefore, the print engine 204 can consume the supply of print material 208. Eventually, the print engine 204 may deplete the supply of print material 208. As a result, the print cartridge 206 may be replaced with another print cartridge (not shown).

The print cartridge 206 includes a memory (cartridge memory) 210 that can store electronic data. The cartridge memory 210 is physically attached to the housing 207 of the print cartridge 206. Thus, when the print cartridge 206 is removed, the cartridge memory 210 goes with the print cartridge 206.

The control system 202 controls the operation of the printing device 106. As shown, the control system 202 may include a processor 212, a real-time clock 214, a memory 216 and an Input-Output (I/O) Port 218. Additionally, the control system 202 includes a cartridge memory read/write (MRW circuit) 220 and a detector 222.

The printer memory 216 stores various firmware modules 217. The processor 212 may execute the firmware modules 217 to enable the control system 202 to perform various control functions. The I/O port 218 enables the control system 202 to, for example, communicate over the communication link 108.

The MRW circuit 220 enables the control system 202 to read and write data to the print cartridge memory 210 when the print cartridge 206 is installed in the printing device 106. It is noted that in some implementations, for example, the MRW circuit 220 may communicate wirelessly with the cartridge memory 210. In other implementations, the MRW circuit 220 may communicate with the cartridge memory 210 over a physical connection that is temporarily established when the print cartridge is installed in the printing device 106.

The detector 222 enables the control system 202 to detect when a print cartridge (e.g., the print cartridge 206) is installed into the printing device 106. The detector 222 may represent, for example, any suitable type of sensor that can sense the presence of the cartridge.

The Real-Time Clock 214 provides the control system 202 with a local source of real-time clock information. It is noted that in other implementations, the real-time clock information may be obtained from a remote source (e.g., a server connected to the printing device 106 over a network).

Component Memory

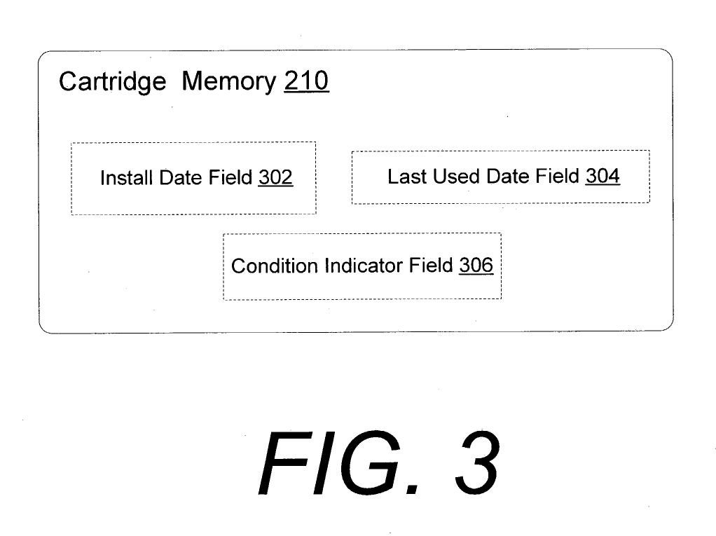

FIG. 3 is a high-level block diagram illustrating certain aspects of the print cartridge memory 210. In this example embodiment, the cartridge memory 210 includes three pre-defined fields for storing data. These fields are designated, in FIG. 3, as follows: install date field 302, last used date field 304 and condition indicator field 306.

For purposes of this document, the “install date” of a component refers to the date the component was installed into a particular device. The “last used date” of a component refers to the date the component was last used by the device.

In this example, the install date field 302 is for storing the date the print cartridge 206 is first installed into a printing device. The last used date field 304 is for storing the date corresponding to the last time the same printing device used the print cartridge 206 to generate printed output.

The condition indicator field 306 is for storing a “condition indicator” for the print cartridge 206. In this example, the condition indicator indicates whether the print cartridge 206 is in a “used” or in an “unused condition”. The print cartridge 206 is considered to be in an “unused condition” if the print cartridge 206 has not yet been used to generate printed output. The print cartridge 206 is considered to be in a “used condition” if the print cartridge 206 has been used to generate printed output.

Operation of the Printing Device

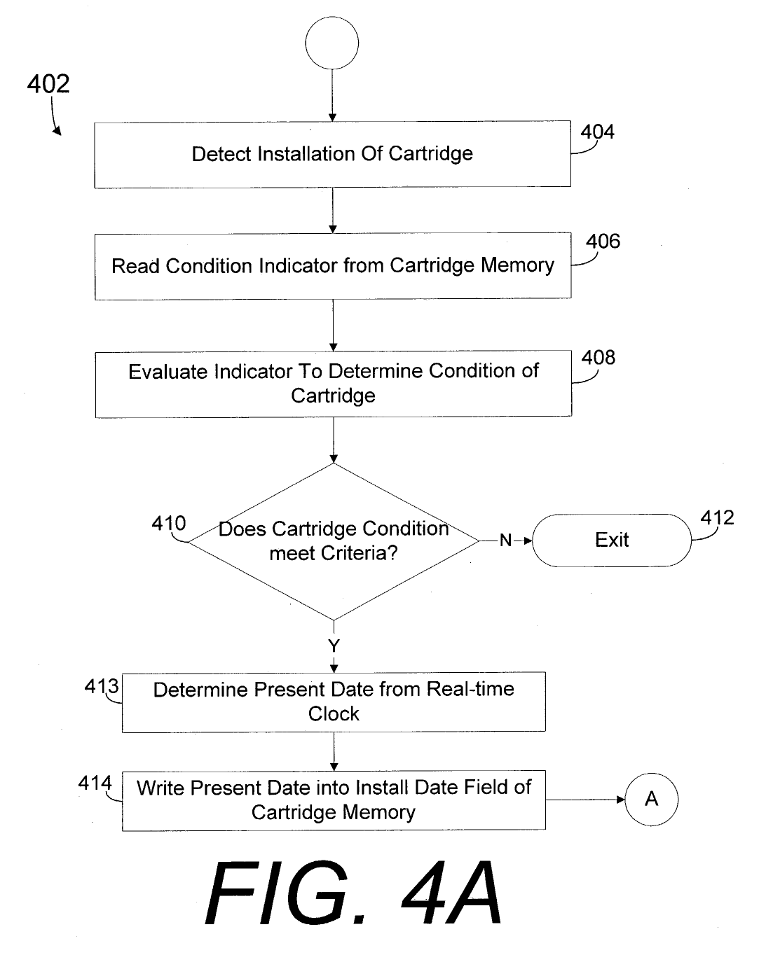

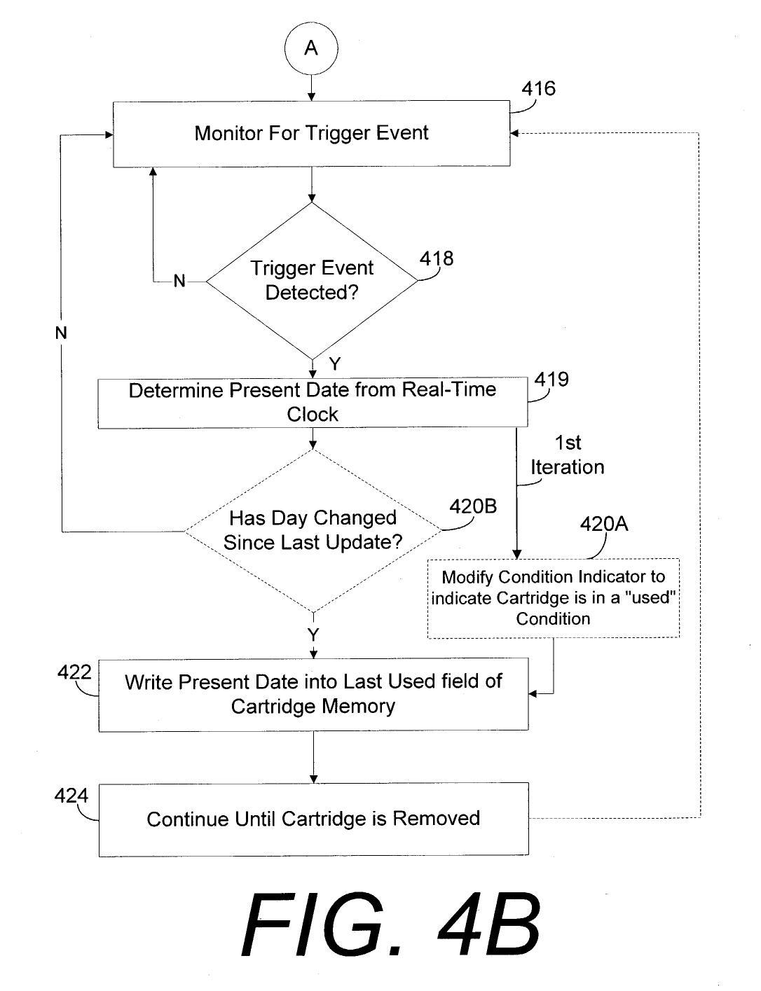

FIG. 4A and FIG. 4B is used to illustrate an exemplary procedure 402 the printing device 106 may follow to update information in the cartridge memory 210. It is noted that the printing device 106 may perform the procedure 402, in whole or in part, at the direction of the processor 212 while executing the firmware modules 217.

Referring to FIG. 4A, the procedure 402 is initiated when the print cartridge 206 is installed into the printing device 106. At block 404, the printing device 106 detects that the print cartridge has been installed.

In response to detecting the installation of the print cartridge 206, the printing device 106 proceeds to read the condition indicator from the cartridge memory 210 (block 406).

The printing device 106 evaluates the condition indicator to determine if the print cartridge 206 is in an “unused” or in a “used” condition (block 408).

If the printing device 106 concludes that the print cartridge 206 is in a “used” condition, the procedure 402 ends (block 410 and block 412).

If, however, the printing device 106 concludes that the print cartridge 206 is in an unused condition, the printing device 106 proceeds to determine, from the real-time clock 214, the present date (block 413).

The printing device 106 writes the present date into the install date field 302 of the cartridge memory 210 (block 414). Thus, in this manner, the date the print cartridge 206 was first installed into the printing device 106 is defined and recorded in the cartridge memory 210.

The printing device 106 then proceeds to monitor for an occurrence of one or more “trigger events” (See FIG. 4B, block 416).

It is noted that a trigger event may be any suitable event that indicates the print cartridge is about to be used, is being used, or has been used by the printing device to generate printed output. Put another way, a trigger event may be any event that is associated with a use of the print cartridge 206 to generate printed output.

For example, a trigger event may include one or more of the following events:

a) The printing device 106 receiving a print job;

b) The printing device 106 consuming a portion of the print material supply 208;

c) The printing device 106 placing a mark on a print medium;

d) The printing device 106 printing a page; and/or

e) The printing device completing a print job.

In response to detecting an occurrence of a trigger event (block 418), the printing device 106 determines, from the real-time clock 214, the present date (block 419).

If this is the first time the printing device 106 has detected a trigger event, the printing device 106 proceeds to modify the condition indicator so that it now indicates that the print cartridge 206 is in a used condition (block 420A).

The printing device 106 then proceeds to write the date determined at block 419 into the last used date field 304 of the cartridge memory 210 (block 422). Thus, in this manner, the date the print cartridge 206 was last used is defined and recorded in the cartridge memory 210.

The printing device 106 then continues to monitor for a trigger event and to update the last used date when the following criteria are met:

Criterion #1: A trigger event is detected (block 416 and block 418); and

Criterion #2: The day has changed since the last time the last used date was updated (block 420B).

Retrieval of the Cartridge Memory Dates

It is noted that the information (e.g., the install date and the last used date) stored in the cartridge memory 210 may be retrieved in any number of ways.

For example, the printing device 106 may allow a user to retrieve this information. In one implementation, for example, the printing device 106 allows a user to submit (either locally or remotely) a request to the printing device 106 for the install date and the last used date of the print cartridge 206. The printing device 106 may respond to the request by reading this information from the cartridge memory 210 and then providing this information to a user in some manner. For example, the printing device 106 may print this information and/or display this information on a local display panel (not shown). Alternatively, the printing device 106 may cause a remote device (e.g., the computer 104) to display the requested information.

In some implementations, the information stored in the cartridge memory 210 may be retrieved after the print cartridge 206 is removed from the printing device 106. For example, the print cartridge 206 may be removed from the printing device 106 and physically sent to a recycling center. The install date and the last used date may be retrieved from the cartridge memory 210 at the recycling center and then stored in a database.

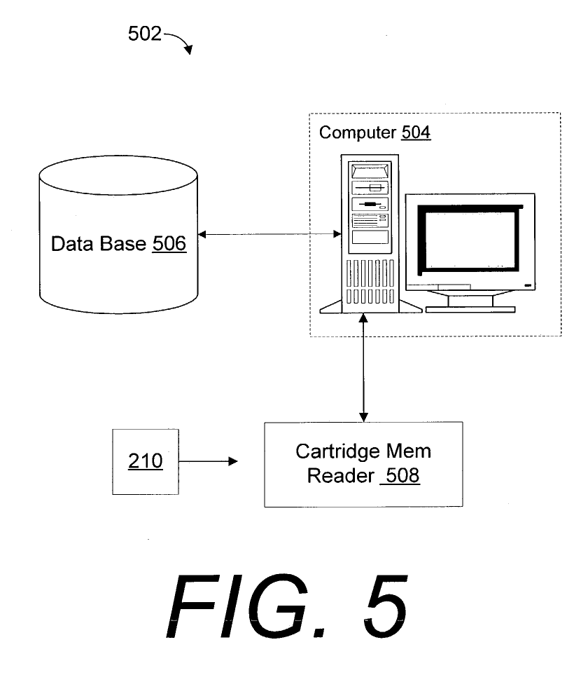

FIG. 5 illustrates a computer system 502 that may be used at such a recycling center to retrieve an install date and a last used date from a print cartridge memory (e.g., cartridge memory 210).

As shown, the system 502 includes a computer 504, a database 506 and a cartridge memory reader 508. The cartridge memory reader 508 includes the appropriate hardware to enable the computer 504 to read the install date and the last used date from the memory of a print cartridge. The database 506 is configured so that dates can be tagged as an install date or a last used date. Furthermore, these dates can be logically link to a unique cartridge identifier.

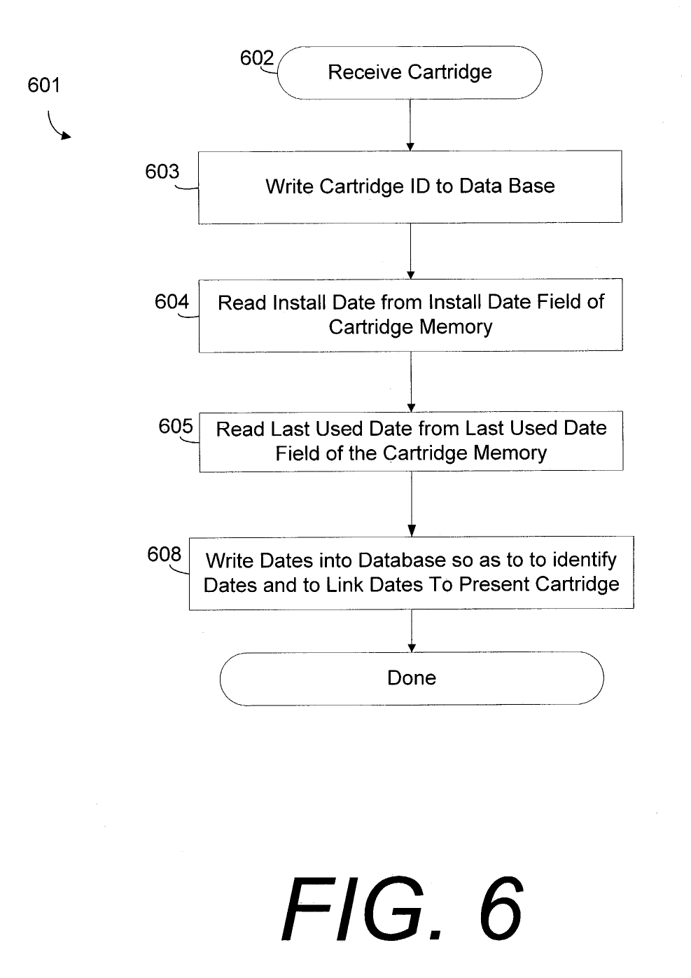

FIG. 6 is a flow diagram illustrating an exemplary procedure 601 the computer 504 may follow to retrieve the install date and the last used date from the cartridge memory 210 after the print cartridge 206 is removed from the printing device 106. It is noted that the operation of the computer 504 to perform the procedure 601 may be partly or wholly automated by, for example, the execution of one or more software programs running on the computer 504.

Referring to FIG. 6, the print cartridge 206 is presented to the cartridge memory reader 508 in such a manner so as to enable the reader 508 to read data from the cartridge memory 210 (block 602).

At block 603, the computer 504 writes a unique “cartridge identifier” into the database 502 (the identifier identifies the cartridge 206). It is noted that in some implementations, the computer 504 may generate the cartridge identifier automatically.

In other implementations, the cartridge identifier may be pre-determined by, for example, the cartridge manufacturer and/or the printing device 106. Further, the cartridge identifier may be stored in the cartridge memory 210. At block 603, therefore, computer 504 may obtain the cartridge identifier directly from the memory 210.

At block 604, the computer 504 reads a first date from the install date field 302 of the cartridge memory 210. At block 605, the computer 504 reads a second date from the last used date field 304 of the cartridge memory 210.

At block 608, the computer 504 operates to write the first and the second date to the database 506. This is done in a manner so that:

a) The first date is tagged as the install date for the print cartridge corresponding to the cartridge ID;

b) The second date is tagged as the last used date for the print cartridge corresponding to the cartridge ID.

Thus in this manner, the database 506 is populated with the install date and last used date for the print cartridge 206. The computer 504 may follow a similar procedure to populate the database 506 with install dates and last used dates for other cartridges.

The information corresponding to the database 506 can then be used for any number of purposes. For example, the information may be used to determine customer usage patterns and/or forecasting future sales of print cartridges.

Other Embodiments

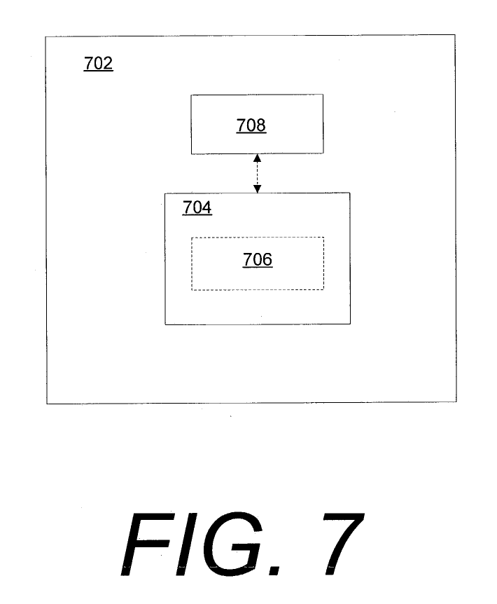

FIG. 7 illustrates another example embodiment of the invention in the form of a printing device 702. The printing device 702 may represent any type of printing device (e.g., a stand-alone printing device, a networked printing device, etc). Additionally, the printing device 702 may perform functions in addition to printing. For example, the printing device 702 may allow a user to scan documents, e-mail scanned documents, etc. In other examples, the printing device 702 may represent a commercial printing press.

As shown the printing device 702 includes a component 704. The component 704 may represent any component that is used in the printing device 702. The component 704 includes a memory 706. The printing device 702 includes a mechanism 708 that is used to store and maintain data in the memory 706. The mechanism 708 may represent, for example, an aspect of the printer control system.

The data that is stored in the integrated memory and maintained by the mechanism 708 indicates a date. The date may be the install date of the component 704 or the last used date of the component 704. In other examples, the data may represent the length of time the component has been installed in the printing device 702.

It is also noted that the present invention may be embodied in the form of a “computer-readable medium”. As used herein, the phrase “computer-readable medium” can refer to any medium that can contain, store or propagate computer executable instructions. Thus, in this document, the phrase “computer-readable medium” may refer to a medium such as an optical storage device (e.g., a Compact Disc), a magnetic storage device (e.g., a magnetic tape), a semi-conductor storage device, etc. The phrase “computer-readable medium” may also refer to signals that are used to propagate the computer executable instructions over a network or a network system, such as the Public Internet.

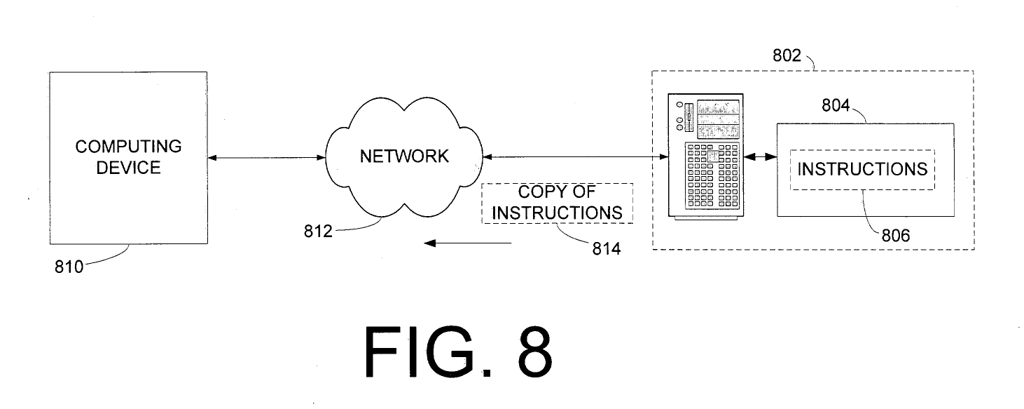

FIG. 8 is a block diagram of an exemplary server system 802. The server system 802 includes a memory 804 that stores a set of computer readable instructions 806. The computer readable instructions 806 are executable by a processor in a printing device to perform, for example, one or more of the acts depicted in FIG. 4A-4B.

As shown, the server system 802 is connected to a computing device 810 via a network 812. The network 812 may include, for example, the Public Internet. The server system 802 can transmit a copy of the computer readable instructions 806 to the computing device 810. The server system 802 performs this function by generating and transmitting a set of signals 814 that embody a copy of the instructions.

It is noted that the memory 804 is a computer-readable medium and represents an embodiment of the invention. Additionally, the signals 814 used to propagate a copy of the instructions 806 to the computing device 810 are also considered a type of “computer-readable medium”. These signals, therefore, represent yet another embodiment of the invention.

Although several specific embodiments of the invention have been described and illustrated, the invention is not to be limited to specific forms or arrangements of parts so described and illustrated. The invention is limited only by the claims and the equivalents thereof.

1. A method of recording an install date of a print cartridge, comprising:
(a) determining a date the print cartridge was installed in a printing device; and
(b) writing the date into a memory attached to the print cartridge.

2. The method of claim 1, wherein act (a) and act (b) are performed automatically by the printing device.

3. The method of claim 1, further comprising:
(c) determining a second date;
(d) writing the second date into a memory attached to the print cartridge; and
wherein the second date corresponds to when the printing device last used the print cartridge to generate printed output.

4. The method of claim 1, further comprising:
(c) prior to performing act (b), determining whether the print cartridge is in an unused condition; and
(d) wherein the writing act is performed only if the print cartridge is determined to be in an unused condition.

5. The method of claim 1, further comprising:
(c) detecting an occurrence of a trigger event associated with the printing device using the print cartridge;
(d) determining the date the trigger event occurred; and
(e) writing the date determined in act (d) into the memory.

6. The method of claim 1, further comprising:
(c) storing a last used date of the print cartridge into the memory; and
(d) updating the stored last used date as necessary.

7. The method of claim 1, wherein the print cartridge includes a supply of toner.

8. The method of claim 1, wherein the print cartridge includes a supply of ink.

9. A print cartridge, comprising:
a memory; and
wherein the memory includes an install date field for storing an install date of the print cartridge.

10. The print cartridge of claim 9, wherein the memory further includes a last used date field for storing the last used date of the print cartridge.

11. The print cartridge of claim 10, wherein the memory further includes a condition indicator field for storing an indicator for indicating a condition of the print cartridge.

12. The print cartridge of claim 9, further comprising:
a housing for holding a supply of print material for use by a printing device to generate printed output; and
wherein the memory is attached to the housing.

13. The print cartridge of claim 10, wherein the last used date field contains the date the print cartridge was first installed in the printing device.

14. A printing device capable of using a print cartridge to generate printed output, the printing device comprising:
(a) a mechanism to store and maintain data in a memory attached to the print cartridge; and
(b) wherein the data indicates when the print cartridge was first installed into the printing device.

15. The printing device of claim of claim 14, wherein the data further indicates when the print cartridge was last used by the printing device.

16. The printing device of claim 14, further comprising:
(c) a print engine for generating printed output; and
(d) wherein the engine is configured to use a supply of print material contained by the print cartridge to generate the printed output.

17. A printing device, comprising:
(a) means for detecting an installation of a print cartridge, where the print cartridge includes an integrated memory;
(b) means for writing the present date into the cartridge memory in response to the detecting means detecting the installation of the print cartridge.

18. The printing device of claim 17, further comprising:
(c) means for detecting a trigger event;
(d) means for writing the date the trigger event occurred into the cartridge memory.

19. The method of claim 18, wherein the trigger event is an event associated with the printing device using the print cartridge to generate printed output.

20. A method of retrieving data from a memory of a print cartridge, comprising:
(a) reading an install date of the print cartridge from the print cartridge memory; and
(b) storing the install date of the print cartridge into a database.

21. The method of claim 20, further comprising:
(c) reading a last used of the print cartridge from the print cartridge memory; and
(d) storing the last used date into the database.

22. One or more computer-readable media having computer-readable instructions embodied thereon which, when executed by one or more processors in a printing device, cause the one or more processors to:
store an install date of a component in the printing deice into a memory; and
wherein the memory is attached to the component.

23. The one or more or more computer-readable media of claim 22, wherein the computer-readable instructions further cause the one or more processors to:
maintain a last used date of the component in the memory.

24. The one or more or more computer-readable media of claim 22, wherein the component is a print cartridge.

25. The one or more computer-readable media of claim 22, wherein the computer-readable instructions further cause the one or more processors to:
initially store a last used date of the component into the memory; and
update, if necessary, the last used date each time the printing device prints a print job.
